(19) United States
(12) Patent Application Publication
(10) Pub. No.: US 2026/0073608 A1
(43) Pub. Date: Mar. 12, 2026

(54) TRAINING INSTANCES OF MACHINE LEARNING MODEL FOR FACIAL EXPRESSION PREDICTION AND GENERATING NEW AVATARS USED IN TRAINING

(71) Applicants: Hewlett-Packard Development Company, L.P., Spring, TX (US); Purdue Research Foundation, West Lafayette, IN (US)

(72) Inventors: Yingying Huang, Taipei City (TW); Xiaoyu Ji, West Lafayette, IN (US); Jishang Wei, Guilford, CT (US); Justin Yang, West Lafayette, IN (US); Prahalathan Sundaramoorthy, Palo Alto, CA (US); Shibo Zhang, Palo Alto, CA (US); Fengqing Zhu, West Lafayette, IN (US); Jan Philip Allebach, West Lafayette, IN (US); Qian Lin, Palo Alto, CA (US)

(73) Assignees: Hewlett-Packard Development Company, L.P., Spring, TX (US); Purdue Research Foundation, West Lafayette, IN (US)

(21) Appl. No.: 19/106,170

(22) PCT Filed: Sep. 2, 2022
(86) PCT No.: PCT/US2022/042439

§ 371 Date: Feb. 24, 2025

(51) Int. Cl. G06T 13/40; G06V 40/16

(52) U.S. Cl. CPC G06T 13/40; G06V 40/176

(57) ABSTRACT

For each avatar, testing images are rendered for different facial expressions that each have ground truth facial action units. An instance of a machine learning model is applied to the testing images to generate predicted facial action units for each testing image. A predictive performance of the instance is calculated for each avatar based on the predicted and ground truth facial action units for the testing images of the avatar. A first set of features common to the avatars for which the predictive performance was better than a first threshold, and a second set of features common to the avatars for which the predictive performance was worse than a second threshold, are identified. The features present only in the second set are identified, as difference features. New avatars having the difference features are generated.

WO

### BACKGROUND

Extended reality (XR) technologies include virtual reality (VR), augmented reality (AR), and mixed reality (MR) technologies, and quite literally extend the reality that users experience. XR technologies may employ head-mountable displays (HMDs). An HMD is a display device that can be worn on the head. In VR technologies, the HMD wearer is immersed in an entirely virtual world, whereas in AR technologies, the HMD wearer's direct or indirect view of the physical, real-world environment is augmented. In MR, or hybrid reality, technologies, the HMD wearer experiences the merging of real and virtual worlds.

### BRIEF DESCRIPTION OF THE DRAWINGS

FIGS. 1A and 1B are perspective and front view diagrams, respectively, of an example head-mountable display (HMD) that can be used in an extended reality (XR) environment.

FIG. 2 is a diagram of an example process for predicting facial action units for a facial expression of the wearer of an HMD from facial images of the wearer captured by the HMD.

FIGS. 3A, 3B, and 3C are diagrams of example facial images of the wearer of an HMD captured by the HMD, on which basis facial action units for the wearer's facial expression can be predicted.

FIG. 4 is a diagram of an example avatar that can be rendered to have the facial expression of the wearer of an HMD based on facial action units predicted for the wearer's facial expression.

FIG. 5 is a diagram of an example process for training instances of a machine learning model that can be used to predict facial action units in FIG. 2.

FIG. 6 is a diagram of example simulated HMD-captured training images of a rendered avatar, on which basis a machine learning model for predicting facial action units can be trained.

FIG. 7 is a flowchart of an example process for generating new avatars on which basis a machine learning model that can be used to predict facial action units in FIG. 2 can be retrained via the process of FIG. 5.

FIG. 8 is a flowchart of an example method.

FIG. 9 is a diagram of an example non-transitory computer-readable data storage medium.

FIG. 10 is a block diagram of an example system including an HMD.

### DETAILED DESCRIPTION

As noted in the background, a head-mountable display (HMD) can be employed as an extended reality (XR) technology to extend the reality experienced by the HMD's wearer. An HMD can include one or multiple small display panels in front of the wearer's eyes, as well as various sensors to detect or sense the wearer and/or the wearer's environment. Images on the display panels convincingly immerse the wearer within an XR environment, be it a virtual reality (VR), augmented reality (AR), a mixed reality (MR), or another type of XR.

An HMD can include one or multiple cameras, which are image-capturing devices that capture still or motion images. For example, one camera of an HMD may be employed to capture images of the wearer's lower face, including the mouth. Two other cameras of the HMD may be each be employed to capture images of a respective eye of the HMD wearer and a portion of the wearer's face surrounding the eye.

In some XR applications, the wearer of an HMD can be represented within the XR environment by an avatar. An avatar is a graphical representation of the wearer or the wearer's persona, may be in three-dimensional (3D) form, and may have varying degrees of realism, from cartoonish to nearly lifelike. For example, if the HMD wearer is participating in an XR environment with other users wearing their own HMDs, the avatar representing the HMD wearer may be displayed on the HMDs of these other users.

The avatar can have a face corresponding to the face of the wearer of the HMD. To represent the HMD wearer more realistically, the avatar may have a facial expression in correspondence with the wearer's facial expression. The facial expression of the HMD wearer thus has to be determined before the avatar can be rendered to exhibit the same facial expression.

A facial expression can be defined by a set of facial action units of a facial action coding system (FACS). A FACS taxonomizes human facial movements by their appearance on the face, via values, or weights, for different facial action units. Facial action units may also be referred to as blendshapes and/or descriptors, and the values or weights may also be referred to as intensities. Individual facial action units can correspond to particular contractions or relaxations of one or more muscles, for instance. Any anatomically possible facial expression can thus be deconstructed into or coded as a set of facial action units representing the facial expression. It is noted that in some instances, facial expressions can be defined using facial action units that are not specified by the FACS.

Facial avatars can be rendered to have a particular facial expression based on the facial action units of that facial expression. That is, specifying the facial action units for a particular facial expression allows for a facial avatar to be rendered that has the facial expression in question. This means that if the facial action units of the wearer of an HMD are able to be identified, a facial avatar exhibiting the same facial expression as the HMD wearer can be rendered and displayed. One way to identify the facial action units of the wearer of an HMD is to employ a machine learning model that predicts the facial action units of the wearer's current facial expression from facial images of the wearer that have been captured by the HMD.

Techniques described herein can train multiple instances of a machine learning model for predicting facial expression facial action units. The same underlying machine learning model may be trained using the same training data and evaluated using the same testing data, but using different training parameters. The instance of the machine learning model that yields the best predictive performance may then be employed to identify an HMD wearer's facial expression from HMD-captured facial images of the wearer, regardless of who the wearer is. That is, the instance of the model that is employed for facial expression identification may be independent of the wearer of the HMD.

Techniques described herein can also generate new avatars that can be used to retrain and retest the instances of a machine learning model for predicting facial expression facial action units. The initially trained instance of the machine learning model that yields the best predictive performance may be applied to rendered images of avatars. Each avatar has multiple rendered images corresponding to different facial expressions. Features specific to the avatars for which the predictive performance of the model is the worst are identified, and new avatars are generated having these features. The machine learning model can then be retrained based on the new avatars to improve its predictive performance.

Techniques described herein can apply a trained (and retrained) instance of a machine learning model to facial images of a wearer of an HMD as captured by cameras of the HMD. The captured facial images can be subjected to preprocessing so that they better resemble the synthetically rendered images on which basis the machine learning model was previously trained. The machine learning model outputs predicted facial action units corresponding to the wearer's facial expression within the captured images. The facial action units can be subjected to postprocessing for smoothing, so that an avatar corresponding to the wearer that is rendered to have the wearer's facial expression appears more natural and less disjointed.

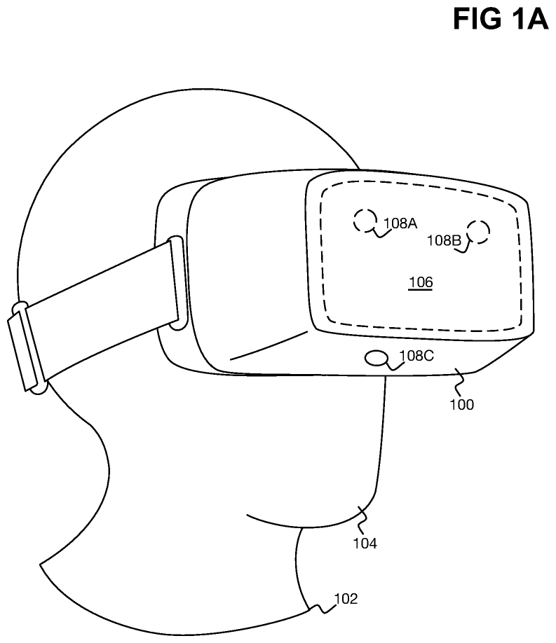

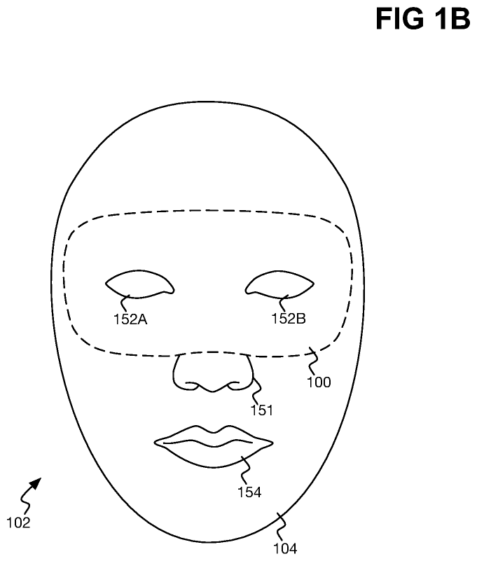

FIGS. 1A and 1B show perspective and front view diagrams of an example HMD 100 worn by a wearer 102 and positioned against the face 104 of the wearer 102 at one end of the HMD 100. Specifically, the HMD 100 can be positioned above the wearer 102's nose 151 and around his or her right and left eyes 152A and 152B, collectively referred to as the eyes 152 (per FIG. 1B). The HMD 100 can include a display panel 106 inside the other end of the HMD 100 that is positionable incident to the eyes 152 of the wearer 102. The display panel 106 may in actuality include a right display panel incident to and viewable by the wearer 102's right eye 152A, and a left display panel incident to and viewable by the wearer 102's left eye 152B. By suitably displaying images on the display panel 106, the HMD 100 can immerse the wearer 102 within an XR.

The HMD 100 can include eye camera 108A and 108B and/or a mouth camera 108C, which are collectively referred to as the cameras 108C. While just one mouth camera 108C is shown, there may be multiple mouth cameras 108C. Similarly, whereas just one eye camera 108A and one eye camera 108B are shown, there may be multiple eye cameras 108A and/or multiple eye cameras 108B. The cameras 108 capture images of different portions of the face 104 of the wearer 102 of the HMD 100, on which basis the facial action units for the facial expression of the wearer 102 can be predicted.

The eye cameras 108A and 108B are inside the HMD 100 and are directed towards respective eyes 152. The right eye camera 108A captures images of the facial portion including and around the wearer 102's right eye 152A, whereas the left eye camera 108B captures images of the facial portion including and around the wearer 102's left eye 152B. The mouth camera 108C is exposed at the outside of the HMD 100, and is directed towards the mouth 154 of the wearer 102 (per FIG. 1B) to capture images of a lower facial portion including and around the wearer 102's mouth 154.

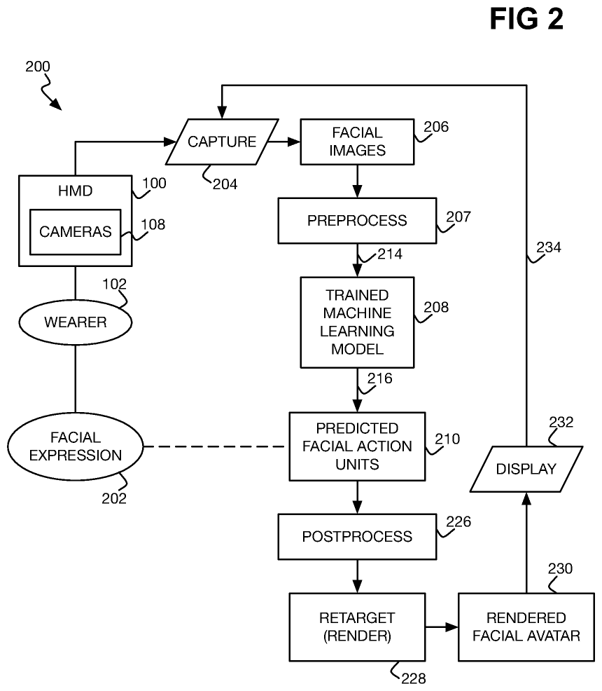

FIG. 2 shows an example process 200 for predicting facial action units for the facial expression of the wearer 102 of the HMD 100, which can then be retargeted onto an avatar corresponding to the wearer 102's face to render the avatar with a corresponding facial expression. The cameras 108 of the HMD 100 capture (204) a set of facial images 206 of the wearer 102 of the HMD 100 (i.e., a set of images 206 of the wearer 102's face 104), who is currently exhibiting a given facial expression 202. A trained machine learning model 208 is applied to the facial images 206 to predict facial action units 210 for the wearer 102's facial expression 202.

However, prior to application of the trained machine learning model 208 to the captured facial images 206, the facial images 206 may undergo preprocessing (207). The preprocessing of the facial images 206 ensures that the images 206 better resemble synthetically rendered images on which basis the machine learning model 208 was previously trained. For instance, the model 208 may have been trained on training images of avatars that are rendered to have facial expressions corresponding to facial action units. Preprocessing the actually captured facial images 206 makes them better appear as if the images 206 were also synthetically generated, so that the model 208 can more accurately identify the facial expression 202 of the wearer 102. One type of preprocessing that may be performed is adaptive histogram equalization.

The set of preprocessed facial images 206 is then input (214) into the trained machine learning model 208, with the model 208 then outputting (216) predicted facial action units 210 for the facial expression 202 of the wearer 102 based on the facial images 206. The trained machine learning model 208 may also output a predicted facial expression based on the facial images 206, which corresponds to the wearer 102's actual currently exhibited facial expression 202. Specific details regarding the machine learning model 208, particularly how training data can be generated for training the model 208, are provided later in the detailed description.

The predicted facial action units 210 for the facial expression 202 of the wearer 102 of the HMD 100 may then be retargeted (228) onto an avatar 230 corresponding to the face 104 of the wearer 102 to render the avatar 230 with this facial expression 202. However, prior to rendering the avatar 230, postprocessing may be performed (226) to smooth the predicted facial action units 210. Smoothing the facial action units 210 can ensure that when they are retargeted onto the avatar 230, the resulting rendered avatar has a facial expression that appears more natural and lifelike, and does not appear disjointed. One type of postprocessing that may be performed is average mean filtering.

The result of facial action unit retargeting is thus an avatar 230 for the wearer 102. The avatar 230 has the same facial expression 202 as the wearer 102 insofar as the predicted facial action units 210 (as have been postprocessed for smoothing) accurately reflect the wearer 102's facial expression 202. The avatar 230 is rendered from the predicted facial action units 210 in this respect, and thus has a facial expression corresponding to the facial action units 210.

The avatar 230 for the wearer 102 of the HMD 100 may then be displayed (232). For example, the avatar 230 may be displayed on the HMDs worn by other users who are participating in the same XR environment as the wearer 102. If the facial action units 210 are predicted by the HMD 100 or by a host device, such as a desktop or laptop computer, to which the HMD 100 is communicatively coupled, the HMD 100 or host device may thus transmit the rendered avatar 230 to the HMDs or host devices of the other users participating in the XR environment. In this respect, it is said that the HMD 100 or the host device indirectly displays the avatar 230, insofar as the avatar 230 is transmitted for display on other HMDs.

In another implementation, however, the HMD 100 may itself display the avatar 230. In this respect, it is said that the HMD 100 or the host device directly displays the avatar 230. The process 200 can be repeated with capture (204) of the next set of facial images 206 (234).

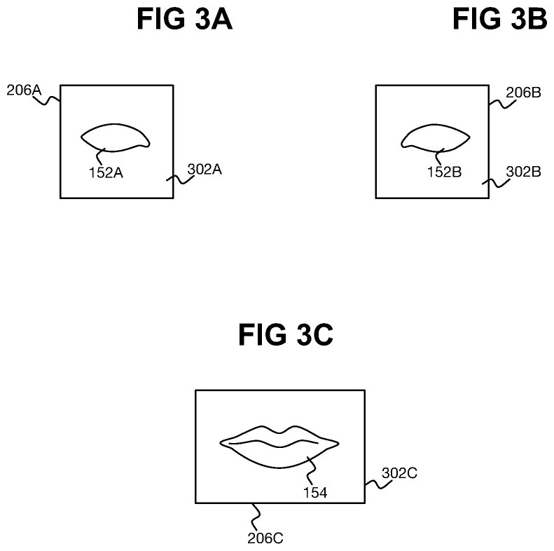

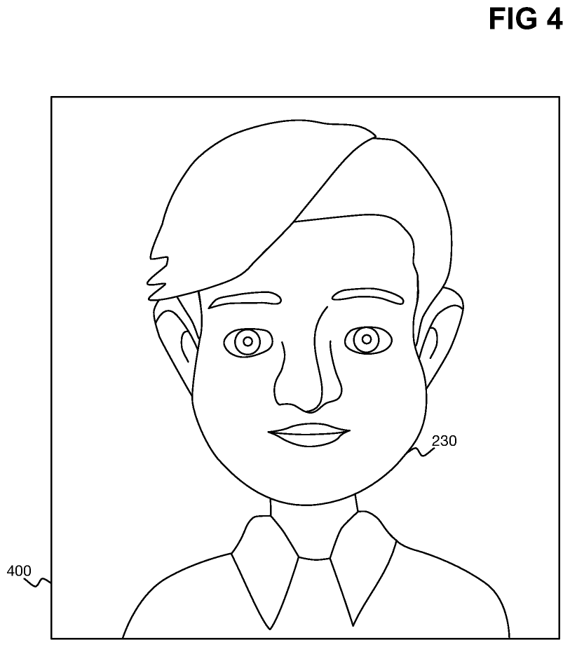

FIGS. 3A, 3B, and 3C show an example set of HMD-captured images 206A, 206B, and 206C, respectively, which are collectively referred to as the images 260 and thus can constitute the images 206 to which the trained machine learning model 208 is applied to generate predicted facial action units 210. The image 206A is of a facial portion 302A including and surrounding the wearer 102's right eye 152A, whereas the image 206B is of a facial portion 302B including and surrounding the wearer 102's left eye 152B. The image 206C is of a lower facial portion 302C including and surrounding the wearer 102's mouth 154. FIGS. 3A, 3B, and 3C thus show examples of the types of images that can constitute the set of facial images 206 used to predict the facial action units 210.

FIG. 4 shows an example image 400 of an avatar 230 that can be rendered when retargeting the predicted facial action units 210 onto the avatar 230. In the example, the avatar 230 is a two-dimensional (2D) avatar, but it can also be a 3D avatar. The avatar 230 is rendered from the predicted facial action units 210 for the wearer 102's facial expression 202. Therefore, to the extent that the predicted facial action units 210 accurately encode the facial expression 202 of the wearer 102, the avatar 230 has the same facial expression 202 as the wearer 102.

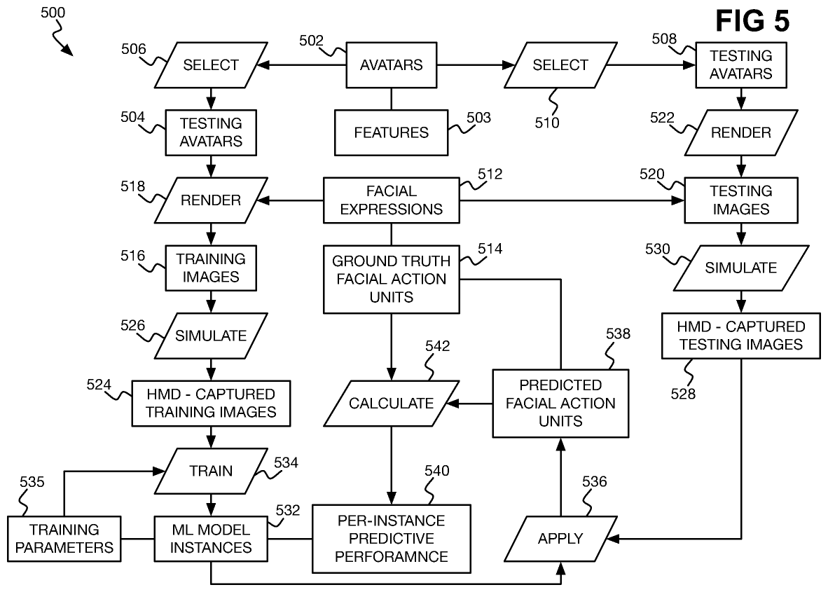

FIG. 5 shows an example process 500 for training instances 532 of the machine learning model 208 that can be used to predict facial action units 210 from HMD-captured facial images 206 of the wearer 102 of the HMD 100. There is a pool of avatars 502 that have corresponding features 503. The avatars 502 may each be defined as a 3D model, with features 503 corresponding to different ethnicities, races, genders, and ages so that the avatars 502 reflect diversity found among people throughout the world. The features 503 can include facial geometry features, such as face shape, lip shape, skin color, wrinkles, and so on.

Training avatars 504 are selected (506) from the pool of avatars 502, and testing avatars 508 are likewise selected (510). The training avatars 504 are used for training the machine learning model instances 532, whereas the testing avatars 508 are used for testing the instances 532 after training. The training avatars 504 can be mutually exclusive with the testing avatars 508, such that no training avatar 504 is also a testing avatar 508 and vice-versa. How the training avatars 504 and the testing avatars 508 are selected from the pool of avatars 502 can be selected in a number of different ways.

For example, the training avatars 504 may be selected as having one gender, whereas the testing avatars 508 may be selected as having another different gender. The training avatars 504 may be selected as having certain skin colors (e.g., darker or lighter), whereas the testing avatars 508 may be selected as having other skin colors (e.g., lighter or darker). The training avatars 504 may be selected as being above (or below) a certain age, whereas the testing avatars 508 may be selected as being below (or above) the same or different certain age. The training avatars 504 and the testing avatars 508 may be selected randomly from the pool of avatars 502.

There are different facial expressions 512 that each correspond to known ground truth facial action units 514. Because the facial action units 514 parameterize facial structures with corresponding facial expressions 512, training images 516 of each training avatar 504 can be rendered (518) and testing images 520 of each testing avatar 508 can likewise be rendered (522). That is, the facial action units 514 for each facial expression 512 are retargeted onto each training avatar 504 to generate training images 516 for that avatar 504, and are retargeted onto each testing avatar 508 to generate training images 520 for that avatar 508.

For example, there may be M training avatars 504 and N testing avatars 508, where M may be equal to or different than N. There may also be a set of P facial expression 512 that each have specified ground truth facial action units 514. Therefore, the result is a set of M×P training images 516 and a set of N×P testing images 520. Rendering of a training avatar 504 or a testing avatar 508 based on specified facial action units 514 results in the avatar 504 or 508 exhibiting the facial expression 512 corresponding to these facial action units 514. The resulting training image 516 of the training avatar 504 or the resulting testing image 520 of the testing avatar 510 is known to correspond to the specified ground truth facial action units 514, since the avatar 504 or 510 was rendered based on these facial action units 514.

For each training image 516 of each training avatar 504, a set of HMD-captured avatar training images 524 can be simulated (524). The HMD captured training images 524 simulate how an actual HMD (e.g., the HMD 100), would capture the face of an avatar 504 if the avatar 504 were a real person wearing the HMD. The simulated HMD-captured training images 524 can thus correspond to actual HMD-captured facial images 206 of an actual HMD wearer 102 in that the images 524 can be roughly of the same size and resolution as and can include comparable or corresponding facial portions to those of the actual images 206. Similarly, for each testing image 520 of each testing avatar 508, a set of HMD-captured avatar testing images 528 can be simulated (530).

Instances 532 of the machine learning model 208 are then individually trained (534) using the simulated HMD-captured training images 524. Each instance 532 corresponds to the same machine learning model 208, but is trained using different training parameters (535). Examples of training parameters include learning rate and step size. Learning rate is the amount by which weights are updated during training of the model 208 in the case of a neural network. The learning rate may be selected between the range of 0.0 and 1.0, for instance. Step size is the number of epochs by which learning rate is adjusted to optimize training of the model 208, where an optimally selected step size shortens training time.

Other example training parameters include the optimization algorithm that is employed during training (e.g., gradient descent, stochastic gradient descent, or Adam optimizer), the cost or loss function used during training, and the number of iterations or epochs used during training of the machine learning model 208. Still other example training parameters include which channels to use during training. For example, the training images 524 may have red, green, and blue color channels, such that different combinations of one or more of these channels may be used during training of the model 208. In one implementation, there may be between 3 and 7 machine learning model instances 532 having corresponding training parameters 535.

The machine learning model 208 may itself be or include a convolutional neural network having convolutional layers followed by a pooling layer that generates, identifies, or extracts image features to predict facial action units from input images. Examples include different versions of the MobileNet machine learning model. The MobileNet machine learning model is described in A. Howard et al., “MobileNets: Efficient Convolutional Neural Networks for Mobile Vision Applications,” arXiv: 1704.04861 [cs.CV], April 2017; M. Sandler et al. “MobileNetV2: Inverted Residuals and Linear Bottlenecks,” arXiv: 1801.104381 [cs.CV], March 2019; and A. Howard et al., “Search for MobileNetV3,” arXiv: 1905.02244 [cs.Cv], November 2019.

In one implementation, the machine learning model 208 may be a two-stage machine learning model. The first stage may be a backbone network, such as a convolutional neural network (e.g., a version of the MobileNet machine learning model) to extract image features (not to be confused with the features 503 of the avatars 502) from the training images 524. The second stage may be another convolutional neural network, such as a regression-type network, to predict facial action units for each training image 516 from the image features that have been extracted.

The machine learning model 208 may be trained to minimize a loss value between the specified ground truth facial action units 514, and predicted facial action units output by the model 208. For example, the loss value that is minimized can be the mean absolute error (MAE). Another loss value example is by the mean square error (MSE).

Once each instance 532 of the machine learning model 208 has been trained, the machine learning model instances 532 are applied (536) to the HMD-captured testing images 528 to generate predicted facial action units 538. For each testing image 520 of a testing avatar 508 corresponding to ground truth facial action units 514, there are corresponding predicted facial action units 538 output by each instance 532 of the model 208. For example, if there are P testing images 520 for each of N testing avatars 508, corresponding to P facial expressions 512 that each have ground truth facial action units 514, and if there are Q instances 532, then are P×N×Q sets of predicted facial action units 538.

Per-instance predictive performance 540 of the machine learning model 208 is calculated (542). The predictive performance of an instance 532 of the machine learning model 208 in predicting the ground truth facial action units 514 is based on how closely each set of predicted facial action units 538 output by that instance 532 matches its corresponding set of ground truth facial action units 514. The predictive performance 540 may be calculated as the MAE or MSE between the predicted facial action units 538 and their corresponding ground truth facial action units 514. In one implementation, the instance 532 having the best predictive performance 540 is used in the process 200 for predicting facial action units 210 corresponding to the facial expression 202 exhibited by the HMD wearer 102 within captured facial images 206.

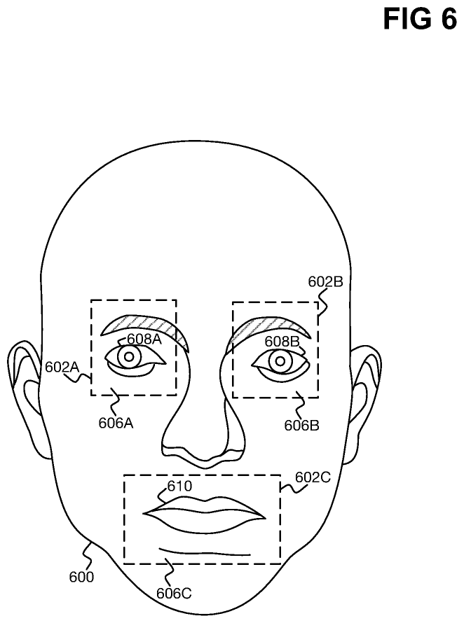

FIG. 6 shows an example rendered avatar image 600 of an avatar 502, such as a training image 516 of a training avatar 504 or a testing image 520 of a testing avatar 508. FIG. 6 also shows example HMD-captured images 602A, 602B, 602C that are simulated from the rendered avatar image 600 and that can be collectively referred to as the simulated HMD-captured images 602 on which basis each instance 532 of the machine learning model 208 can be actually trained. The HMD-captured images 602 may be the HMD-captured training images 524 simulated from a training image 516 or the HMD-captured testing images 528 simulated from a testing image 520.

The simulated HMD-captured image 602A is of a facial portion 606A surrounding and including the avatar 530's left eye 608A, whereas the image 602B is of a facial portion 606B surrounding and including the avatar 530's right eye 608B. The images 602A and 602B are thus left and right eye avatar images that are simulated in correspondence with actual left and right eye images that can be captured by an HMD, such as the images 206A and 206B of FIGS. 3A and 3B, respectively. That is, the images 602A and 602B may be of the same size and resolution and capture the same facial portions as actual HMD-captured left and right eye images.

The simulated HMD-captured image 602C is of a lower facial portion 606C surrounding and including the avatar 530's mouth 610. The image 602C is thus a mouth avatar image that is simulated in correspondence with an actual mouth image captured by an HMD, such as the image 206C of FIG. 3C. Similarly, then, the image 602C may be of the same size and resolution and capture the same facial portion as an actual HMD-captured mouth image. FIG. 6 thus shows avatar images 602, as opposed to images of an actual HMD wearer.

In general, the avatar images 602 match the perspective and image characteristics of the facial images of HMD wearers captured by the actual cameras of the HMDs on which basis the machine learning model 208 will be used to predict the wearers'facial expressions. That is, the avatar images 602 are in effect captured by virtual cameras corresponding to the actual HMD cameras. The avatar images 602 that have been described reflect just one particular placement of such virtual cameras. More generally, then, depending on the actual HMD cameras used to predict facial expressions of HMD wearers, the avatar images 602 can vary in number and placement.

For example, the HMD mouth cameras may be stereo cameras so that more of the wearers'cheeks may be included within the correspondingly captured facial images, in which case the avatar images 602 corresponding to such facial images would likewise capture more of the rendered avatars'cheeks. As another example, the HMD cameras may also include forehead cameras to capture facial images of the wearers'foreheads, in which case the avatar images 602 would include corresponding images of the rendered avatars'foreheads. As a third example, there may be multiple eye cameras to capture the regions surrounding the wearers'eyes at different oblique angles, in which case the avatar images 602 would also include corresponding such images.

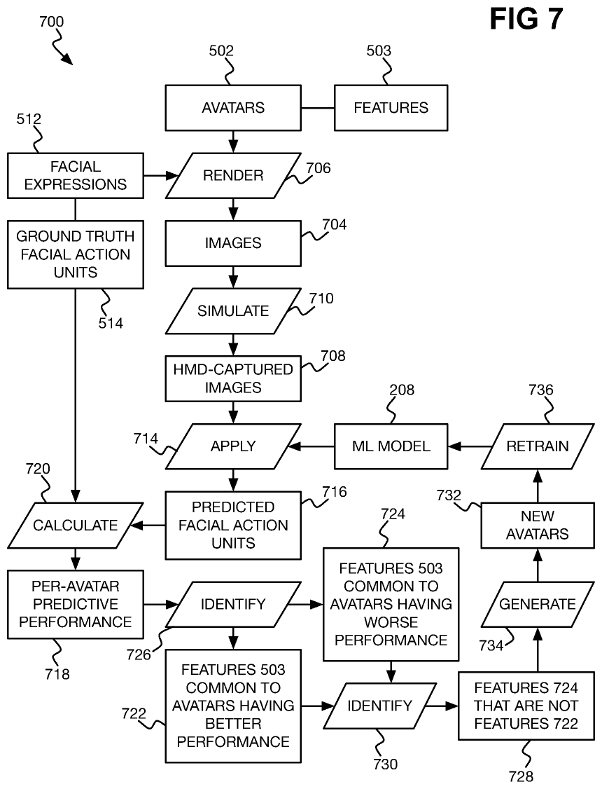

FIG. 7 shows an example process 700 for generating new avatars 732 on which basis the machine learning model instances 532 can be retrained in the process 500. The process 700 is performed after at least one instance 532 of the machine learning model 208 has been initially trained via the process 500. In one implementation, the process 700 may use the instance 532 of the machine learning model 208 that had the best per-instance predictive performance 540 of any instance 532.

Images 704 of the avatars 502 having the features 503 can be rendered (706) in correspondence with the facial expression 512 that each have specified ground truth facial action units 514, as before. If the training avatars 504 and the testing avatars 508 together include all the avatars 502, then the training images 516 and the testing images 520 may be reused as the images 704. If the training avatars 504 and the testing avatars 508 together do not include all the avatars 502, then the training images 516 and the testing images 520 may be reused as the images 704 and supplemented by images 704 rendered just for each avatar 502 that is not a training avatar 504 or a testing avatar 508.

HMD-captured images 708 are then simulated (710) from the images 704, also as before. If the training avatars 504 and the testing avatars 508 together include all the avatars 502, then the HMD-captured training images 524 and testing images 528 may be reused as the HMD-captured images 708. If the training avatars 504 and the testing avatars 508 together do not include all the avatars 502, then the HMD captured-training images 524 and testing images 528 may be reused as the HMD-captured images 708 and supplemented by images 708 simulated from the images 704 rendered for each avatar 502 that is not a training avatar 504 or a testing avatar 508.

The machine learning model 208 is then applied (714) to the HMD-captured images 708 to yield or generated predicted facial action units 716. The instance 532 of the machine learning model 208 having the best per-instance predictive performance may be applied, as noted above. For each image 704 of each avatar 502, a set of predicted facial action units 716 is generated that corresponds to the facial expression 512 having the specified ground truth facial action units 514 on which basis that image 704 was rendered.

Per-avatar predictive performance 718 of the machine learning model 208 is calculated (720). For each avatar 502, the predictive performance 718 of the model 208 is calculated based on how well the predicted facial action units 716 that the model 208 generated for the images 704 of the avatar 502 match their corresponding ground truth facial action units 514. The predictive performance 718 for an avatar 502 may be calculated as the MAE or MSE between the predicted facial action units 716 for each image 704 of that avatar 502 and the ground truth facial action units 514 for that image 704.

The predictive performance 718 therefore is the performance of an instance 532 of the machine learning model 208 on a per-avatar basis. By comparison, the predictive performance 540 calculated in the process 500 is the performance of a machine learning model instance 532 on a per-instance basis. For the instance 532 used in the process 700, the per-instance predictive performance 540 is its predictive performance over all training avatars 504, and not just a single avatar 502 as is the case with the per-avatar predictive performance 718.

The features 503 that are common to the avatars 502 having better predictive performance 718 are identified (726), as a (first) set 722 of the features 503. The features 503 that are common to the avatars 502 having worse predictive performance 718 are also identified (726), as a (second) set 724 of the features 503. For instance, each of the features 503 that is present in each avatar 502 having predictive performance 718 greater than a (first) threshold is added to the set 722. Similarly, each of the features 503 that is present in each avatar 502 having predictive performance 718 less than a (second) threshold is added to the set 724.

In one implementation, the avatars 502 may be categorized over quartiles by their per-avatar predictive performance 718, so that each quartile includes an equal or substantially equal number of avatars 502. The avatars 502 having better predictive performance 718 are those in the highest quartile, in that they each have a predictive performance 718 greater than the highest predictive performance 718 of any avatar 502 in the next-highest quartile. The avatars 502 having worse performance 718 are those in the lowest quartile, in that the each has a predictive performance less than the lowest predictive performance 718 of any avatar 502 in the next-lowest quartile.

The features 503 that are in the set 724 but not in the set 722 are identified (730), and are referred to as difference features 728. The difference features 728 may be the factors as to why the predictive performance 718 of the machine learning model 208 was worse for certain avatars 502. That is, not all of the features 503 of the set 724 that are common to the avatars 502 for which the model 208 had worse predictive performance 718 may be factors as to why the performance 718 was worse for these avatars 502. For example, any feature 503 in the set 724 that is also in the set 722 may not be a factor as to why the predictive performance 718 of the model 208 was worse for certain avatars 502.

New avatars 732 having the difference features 728 are generated (734). For example, the new avatars 732 may have the same difference features 728, but may have different features 503 other than the features 728. The difference features 728 may be adjusted within a range to generate the new avatars 732. Different avatars 732 may have different combinations of the difference features 728. The new avatars 732 are generated so that the machine learning model 208 can be retrained (736) to improve its predictive performance 718 for the avatars 732 having these features 728.

The process 700 may be repeated a number of times in order to iteratively improve the machine learning model 208. The process 700 thus identifies the features 728 on which basis the model 208 is having difficulty predicting facial action units 716 for facial expression 512 of avatars 706. By adding new avatars 732 having these features 728, and then retraining the machine learning model 208 using the new avatars 732, overall predictive performance 540 can be improved. Just the instance 532 of the machine learning model 208 used in the process 700 may be retrained, or multiple instances 532 of the model 208 may be retrained per the process 500.

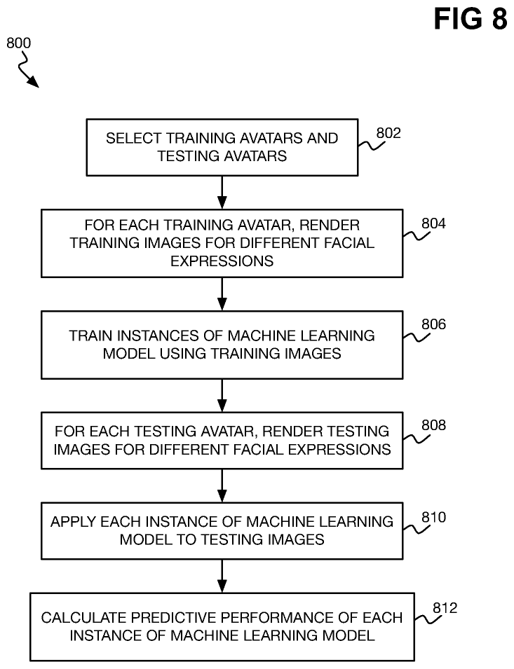

FIG. 8 shows an example method 800. The method 800 may be implemented as program code stored on a non-transitory computer-readable data storage medium and executed by a processor. The method 800 includes selecting training avatars 504 and testing avatars 508 from a pool of avatars 502 (802). The method 800 includes, for each training avatar 504, rendering training images 516 for different facial expressions 512 that each correspond to ground truth facial action units 514 (804). The method 800 includes training instances 532 of a machine learning model 208 using the training images 516 (806), where instance 532 corresponds to different training parameters 535.

The method 800 includes, for each testing avatar 508, rendering testing images 520 for the different facial expressions 512 (808). The method 800 includes applying each instance 532 of the machine learning model 208 to the testing images 520 to generate predicted facial action units 538 for each testing image 520 (810). The method 800 includes calculating a predictive performance of each instance 532 based on the predicted and ground truth facial action units 538 and 514 for the testing images 520 of the testing avatars 508 (812).

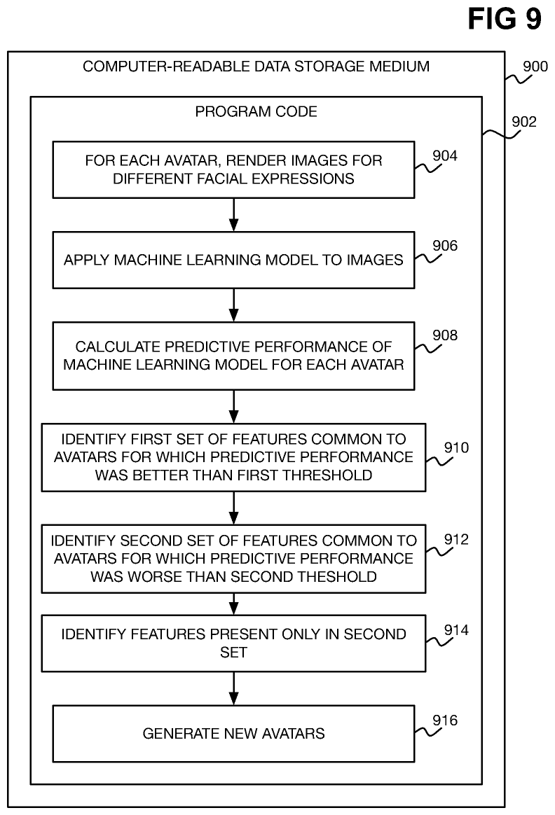

FIG. 9 shows an example non-transitory computer-readable data storage medium 900 storing program code 902 executable by a processor to perform processing. The processing includes, for each of a pool of avatars 502, rendering images 704 for different facial expressions 512 that each have ground truth facial action units 514 (904). The processing includes applying a machine learning model 208 to the images 704 to generate predicted facial action units 716 for each image 704 (906). The processing includes calculating a predictive performance 718 of the machine learning model 208 for each avatar 502 based on the predicted and ground truth facial action units 716 and 514 for the images 704 of the avatar 502 (908).

The processing includes identifying a first set 722 of the features 503 common to the avatars 502 for which the predictive performance 718 was better than a first threshold (910). The processing includes identifying a second set 724 of the features 503 common to the avatars 502 for which the predictive performance 718 was worse than a second threshold (912). The processing includes identifying the features 503 present only in the second set 724 and not in the first set 722 (914), as difference features 728. The processing includes generating new avatars 734 having the difference features 728 (916).

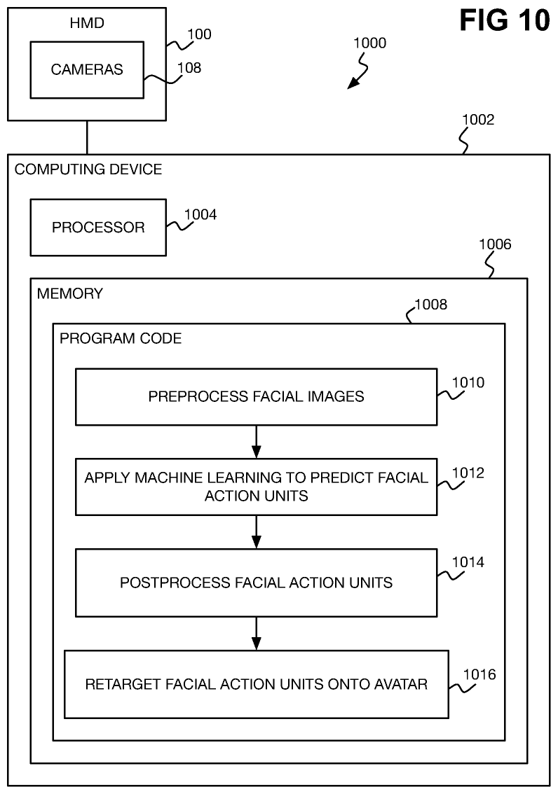

FIG. 10 shows an example system 1000. The system 1000 is depicted as including the HMD 100 and a computing device 1002. The HMD 100 one or multiple cameras 108 to capture a set of facial images 206 of a wearer 102 of the HMD 100. The computing device 1002 has a processor 1004 and a memory 1006 storing program code 1008. The computing device 1002 may be the host device of the HMD 100, for instance. In another implementation, however the processor 1004 and the memory 1006 may be part of the HMD 100. In this case, the processor 1004 and the memory 1006 may be integrated within an application-specific integrated circuit (ASIC), such that the processor 1004 is a special-purpose processor. The processor 1004 may instead be a general-purpose processor, such as a central processing unit (CPU), such that the memory 1006 may be a separate semiconductor or other type of volatile or non-volatile memory 1006.

The program code 1008 is executable by the processor 1004 to perform processing. The processing includes preprocessing the facial images 206 so that the images 206 better resemble synthetically rendered images (1010). The processing includes applying a machine learning model 208 to the preprocessed facial images 206 to generate predicted wearer facial action units 210 for a facial expression 202 of the wearer 102 exhibited within the facial images 206 (1012). The processing includes postprocessing the predicted wearer facial action units 210 to smooth the predicted wearer facial action units 210 (1014). The processing includes retargeting the postprocessed predicted facial action units 210 onto an avatar 230 corresponding to the wearer 102 to render the avatar 230 with the facial expression 202 of the wearer 102 for display (1016).

Techniques have been described for training instances of a machine learning model for facial expression prediction. The machine learning model instances are trained and tested using avatars, and the techniques include generating new avatars to improve predictive performance of the model. The machine learning model may be applied to captured facial images of the wearer of an HMD that have been preprocessed, in order to predict facial action units of the facial expression exhibited by the wearer. The predicted facial action units may be postprocessed and then retargeted on an avatar so that the avatar is rendered with the facial expression of the wearer.

We claim:

1. A non-transitory computer-readable medium storing program code executable by a processor to perform processing comprising:
for each of a plurality of avatars, rendering images for different facial expressions that each have ground truth facial action units;
applying a machine learning model to the images to generate predicted facial action units for each image;
calculating a predictive performance of the machine learning model for each avatar based on the predicted and ground truth facial action units for the images of the avatar;
identifying a first set of features common to the avatars for which the predictive performance was better than a first threshold;
identifying a second set of features common to the avatars for which the predictive performance was worse than a second threshold;
identifying the features present only in the second set, as difference features; and
generating new avatars having the difference features.

2. The non-transitory computer-readable medium of claim 1, wherein the processing further comprises:
retraining the machine learning model using the new avatars.

3. The non-transitory computer-readable medium of claim 2, wherein the processing further comprises:
applying the retrained machine learning model to facial images captured by a head-mountable display (HMD) of a wearer exhibiting a facial expression to generate predicted wearer facial action units for the facial expression of the wearer;
retargeting the predicted wearer facial action units onto an avatar corresponding to the wearer to render the avatar with the facial expression of the wearer; and
displaying the rendered avatar corresponding to the wearer.

4. The non-transitory computer-readable medium of claim 1, wherein rendering the images comprises:
for each different facial expression, rendering a corresponding image for each avatar.

5. The non-transitory computer-readable medium of claim 1, wherein calculating the predictive performance of the machine learning model for each avatar comprises:
calculating a mean absolute error or a mean square error between the predicted facial action units and the ground truth facial action units for the images of the avatar.

6. The non-transitory computer-readable medium of claim 1, wherein the first threshold comprises a highest quartile of the predictive performance over all the avatars,
and wherein the second threshold comprises a lowest quartile of the predictive performance over all the avatars.

7. The non-transitory computer-readable medium of claim 1, wherein the features of the avatars comprise facial geometry features.

8. A method comprising:
selecting training avatars and testing avatars from a plurality of avatars;
for each training avatar, rendering a plurality of training images for different facial expressions that each correspond to ground truth facial action units;
training a plurality of instances of a machine learning model using the training images, each instance corresponding to different training parameters;
for each testing avatar, rendering a plurality of testing images for the different facial expressions;
applying each instance of the machine learning model to the testing images to generate predicted facial action units for each testing image; and
calculating a predictive performance of each instance of the machine learning model based on the predicted and ground truth facial action units for the testing images of the testing avatars.

9. The method of claim 8, further comprising:
applying the instance of the machine learning model having the predictive performance that is best to facial images captured by a head-mountable display (HMD) of a wearer exhibiting a facial expression to generate predicted wearer facial action units of the wearer;
retargeting the predicted wearer facial action units onto an avatar corresponding to the wearer to render the avatar with the facial expression of the wearer; and
displaying the rendered avatar corresponding to the wearer.

10. The method of claim 8, wherein calculating the predictive performance of each instance of the machine learning model comprises:
calculating a mean absolute error between the predicted facial action units generated by the instance and the ground truth facial action units for the testing images of the testing avatars.

11. The method of claim 8, further comprising:
applying the instance of the machine learning model having the predictive performance that is best to the training images to generate the predicted facial action units for each training image;
for each avatar, calculating an avatar-specific predictive performance of the instance of the machine learning model having the predictive performance that is best based on the predicted and ground truth facial action units for the testing avatar;
identifying a first set of features common to the avatars for which the avatar-specific predictive performance was better than a first threshold;
identifying a second set of features common to the avatars for which the avatar-specific predictive performance was worse than a second threshold;
identifying the features present only in the second set, as different features; and
generating new avatars having the difference features; and
retraining the instances of the machine learning model using the new avatars.

12. A system comprising:
a head-mountable display (HMD) having one or multiple cameras to capture a set of facial images of a wearer of the HMD;
a processor; and
a memory storing program code executable by the processor to:
preprocess the facial images so that the images better resemble synthetically rendered images;
applying a machine learning model to the preprocessed facial images to generate predicted wearer facial action units for a facial expression of the wearer exhibited within the facial images;
postprocessing the predicted wearer facial action units to smooth the predicted wearer facial action units; and
retarget the postprocessed predicted facial action units onto an avatar corresponding to the wearer to render the avatar with the facial expression of the wearer for display.

13. The system of claim 12, wherein the processor is to preprocess the facial images by performing adaptive histogram equalization,
and wherein the processor is to postprocess the predicted wearer facial action units by performing average mean filtering.

14. The system of claim 12, wherein the machine learning model is initially trained using a plurality of avatars, and is retrained using new avatars having features specific to the avatars for which predictive performance of the initially trained machine learning model is worse than a threshold.

15. The system of claim 12, wherein the machine learning model that is applied is an instance of a plurality of instances of the machine learning model for which predictive performance was best, each instance corresponding to different training parameters.
